(19) United States
(12) Patent Application Publication
(10) Pub. No.: US 2024/0197551 A1
(43) Pub. Date: Jun. 20, 2024

(54) HYPERBARIC CHAMBERS

(71) Applicant: Tekna Manufacturing Private Limited, Guindy, Chennai (IN)

(72) Inventors: Todd JANCA, Zephyr Hills, FL (US); V. N. SRIRAM, Tamil Nadu, Chennai (IN); Sreekanth NARASIMHAN, Tamil Nadu, Chennai (IN)

(21) Appl. No.: 18/555,682

(22) PCT Filed: Apr. 13, 2022
(86) PCT No.: PCT/IN2022/050356

§ 371 Date: Oct. 16, 2023

(30) Foreign Application Priority Data
Apr. 14, 2021 (IN) 202141017468

(51) Int. Cl. A61G 10/02

(52) U.S. Cl. CPC A61G 10/026; A61G 2200/32; A61G 2200/34

(57) ABSTRACT

A hyperbaric chamber includes a plurality of enclosure sections including a first union enclosure section that has a first top wall, a first bottom wall, a first sidewall having a first opening. a second sidewall having a second opening, a third sidewall having a third opening, and a fourth sidewall having a fourth opening. The first sidewall, the second sidewall, the third sidewall, and the fourth sidewall are connected to the first top wall and the first bottom wall to form an open enclosure. The first door section is connectable to the first opening of the first union enclosure section. The plurality of end enclosure sections is connectable directly or indirectly to each of the second opening, the third opening, and the fourth opening of the union enclosure section. Each enclosure section is connectable to another by disengagable connectors.

### TECHNICAL FIELD

The present subject matter relates, in general, to hyperbaric chambers and, in particular, to hyperbaric chambers in which patients are accommodated and subjected to hyperbaric oxygen therapy.

### BACKGROUND

Hyperbaric oxygen therapy refers to the administration of high concentrations of oxygen, such as 100% oxygen, to patients at elevated pressures, such as 2-3 times the atmospheric pressure. Due to the elevated pressure, the absorption of oxygen in the blood of the patient increases, thereby increasing the concertation of oxygen in the blood. The increased concentration of oxygen in the blood enables treatment of various conditions, such as healing of surgical wounds, burns, and ulcers. To allow subjecting the patient to elevated pressures, the patient may be accommodated, such as seated or in a sleeping posture, in a hyperbaric chamber, which is pressurized to the elevated pressures.

### BRIEF DESCRIPTION OF DRAWINGS

The features, aspects, and advantages of the present subject matter will be better understood with regard to the following description, and accompanying figures. The use of the same reference number in different figures indicates similar or identical features and components.

FIG. 1 illustrates a hyperbaric chamber, in accordance with an implementation of the present subject matter.

FIG. 2a illustrates a hyperbaric chamber, in accordance with an implementation of the present subject matter.

FIG. 2b illustrates an exploded view of a hyperbaric chamber, in accordance with an implementation of the present subject matter.

FIG. 3 illustrates a hyperbaric chamber, in accordance with an implementation of the present subject matter.

FIG. 4(a) illustrates a door section, in accordance with an implementation of the present subject matter.

FIG. 4(b) illustrates an exploded view of a door section, in accordance with an implementation of the present subject matter.

FIG. 4(c) illustrates an exploded view of a door frame, in accordance with an implementation of the present subject matter.

FIG. 4(d) illustrates an exploded view of a door shell assembly, in accordance with an implementation of the present subject matter.

FIGS. 5(a), 5(b), and 5(c) illustrate closed, partially open, and open positions, respectively, of a door, in accordance with an implementation of the present subject matter.

FIG. 6(a) illustrates a union enclosure section, in accordance with an implementation of the present subject matter.

FIG. 6(b) illustrates an exploded view of a union enclosure section, in accordance with an implementation of the present subject matter.

FIGS. 7(a) and 7(b) illustrate assembled and exploded views, respectively, of a shell of a union enclosure section, in accordance with an implementation of the present subject matter.

FIGS. 8(a)-8(c) illustrate assembled and exploded views of a top wall of a union enclosure section, in accordance with an implementation of the present subject matter.

FIGS. 9(a)-9(c) illustrate assembled and exploded views of a bottom wall of a union enclosure section, in accordance with an implementation of the present subject matter.

FIG. 10 illustrates formation of a joint that connects a top wall or a bottom wall of a union enclosure section with a bracket of the union enclosure section, in accordance with an implementation of the present subject matter.

FIG. 11(a) illustrates a seat section, in accordance with an implementation of the present subject matter.

FIG. 11(b) illustrates an exploded view of a seat section, in accordance with an implementation of the present subject matter.

FIGS. 12(a) and 12(b) illustrate an assembled and an exploded view, respectively, of a seat section, in accordance with an implementation of the present subject matter.

FIGS. 13(a) and 13(b) illustrate an assembled view and an exploded view, respectively, of a spacer section, in accordance with an implementation of the present subject matter.

FIGS. 14(a) and 14(b) illustrate an assembled view and an exploded view, respectively, of an end enclosure section, in accordance with an implementation of the present subject matter.

FIG. 15 illustrates assembly of a seat section and an end enclosure section, in accordance with an implementation of the present subject matter.

FIG. 16 illustrates a seating area, in accordance with an implementation of the present subject matter.

FIG. 17 illustrates a seating area, in accordance with an implementation of the present subject matter.

FIG. 18(a) illustrates an intermediate door section, in accordance with an implementation of the present subject matter.

FIG. 18(b) illustrates an exploded view of an intermediate door section, in accordance with an implementation of the present subject matter.

FIGS. 19(a), 19(b), and 19(c) illustrate closed, partially open, and open positions of a door of an intermediate door section, in accordance with an implementation of the present subject matter.

FIG. 20 illustrates a top view of a hyperbaric chamber, in accordance with an implementation of the present subject matter, and

FIG. 21 illustrates a method of assembling a hyperbaric chamber, in accordance with an implementation of the present subject matter.

### DETAILED DESCRIPTION

Hyperbaric chambers are chambers that can accommodate patients, such as in a sitting posture on a seat or a stretcher, or in a sleeping posture on the stretcher, and in which elevated pressures can be applied. A hyperbaric chamber is generally accommodated in a building, such as a hospital or a clinic. Conventionally, the hyperbaric chambers are large, as it has to accommodate one or more patients. Thus, taking the hyperbaric chamber inside the building may be challenging. For instance, it may not be possible to take the hyperbaric chamber through a door of the building, such as a door having a size of 3 ft×7 ft. Accordingly, modifications may have to be made to the building to assemble the hyperbaric chamber inside the building. For instance, a wall having the door may have to be torn down. In some scenarios, a place, such as a room, where the hyperbaric chamber is to be installed may have to be entirely re-designed, such as tearing down one or more walls to increase space of the place to provide sufficient space to accommodate the hyperbaric chamber. Another reason for the difficulty in taking the hyperbaric chamber inside the building may be the large weight of the hyperbaric chamber. Therefore, assembling the conventional hyperbaric chambers is an expensive, time-consuming, and laborious process.

Further, generally, the hyperbaric chamber is not expandable in capacity. For example, a hyperbaric chamber designed for accommodating 12 patients cannot be expanded to accommodate a 13^{th} patient. Accordingly, the entire hyperbaric chamber may have to be replaced.

The present subject matter relates to hyperbaric chambers. The present subject matter provides hyperbaric chambers that are modular, portable, easy to assemble, and expandable.

In an implementation of the present subject matter, a hyperbaric chamber is made from a plurality of enclosure sections. The hyperbaric chamber may be used for hyperbaric oxygen therapy for at least one patient. In an example, the enclosure sections may be assembled together using disengagable connectors, such as bolts and nuts. The assembly of the plurality of enclosure sections may be based on the number of patients to be accommodated in the hyperbaric chamber, the size of the room in which the hyperbaric chamber is to be accommodated, and the like. The plurality of enclosure sections may include a first union enclosure section, a first door section, and a plurality of end sections.

The first union enclosure section may enable expansion of the hyperbaric chamber and may be joined with a plurality of sections and allows for movement between the joined sections. For example, the first union enclosure section may be a hollow structure and may have an opening on each of its sidewalls. In an example, the first union enclosure section may have a first top wall, a first bottom wall, a first sidewall having a first opening, a second sidewall having a second opening, a third sidewall having a third opening, and a fourth sidewall having a fourth opening. The first sidewall, the second sidewall, the third sidewall, and the fourth sidewall may be connected to the first top wall and the first bottom wall to form an open enclosure. The first door section may include a first door frame and a first door. The first door may enable entry and exit of patients into and out of the hyperbaric chamber. The first door section may be connectable to the first opening of the first union enclosure section. The plurality of end enclosure sections may be connectable one of directly or indirectly to each of the second opening, the third opening, and the fourth opening of the union enclosure section. In an example, the cross-section of each enclosure section of the hyperbaric chamber may be substantially rectangular in shape.

Since the hyperbaric chamber can be made by assembling a plurality of enclosure sections, the enclosure sections that are to be used for making the hyperbaric chamber can be individually carried inside a building in which the hyperbaric chamber is to be deployed and assembled inside the building. Thus, carrying the hyperbaric chamber as a whole to the building is avoided. Further, the sections that are used for making the hyperbaric chamber are small, such as smaller than a door. Therefore, the enclosure sections can be carried through a door, thereby preventing tearing down of walls for assembling the hyperbaric chamber. Furthermore, the hyperbaric chamber can be expanded to accommodate more patients by attaching additional union enclosure sections to existing sections of the hyperbaric chamber.

The above and other features, aspects, and advantages of the subject matter will be better explained with regard to the following description, and accompanying figures. It should be noted that the description and figures merely illustrate the principles of the present subject matter along with examples described herein and, should not be construed as a limitation to the present subject matter. It is thus understood that various arrangements may be devised that, although not explicitly described or shown herein, embody the principles of the present disclosure. Moreover, all statements herein reciting principles, aspects, and examples thereof, are intended to encompass equivalents thereof. Further, for the sake of simplicity, and without limitation, the same numbers are used throughout the drawings to reference like features and components.

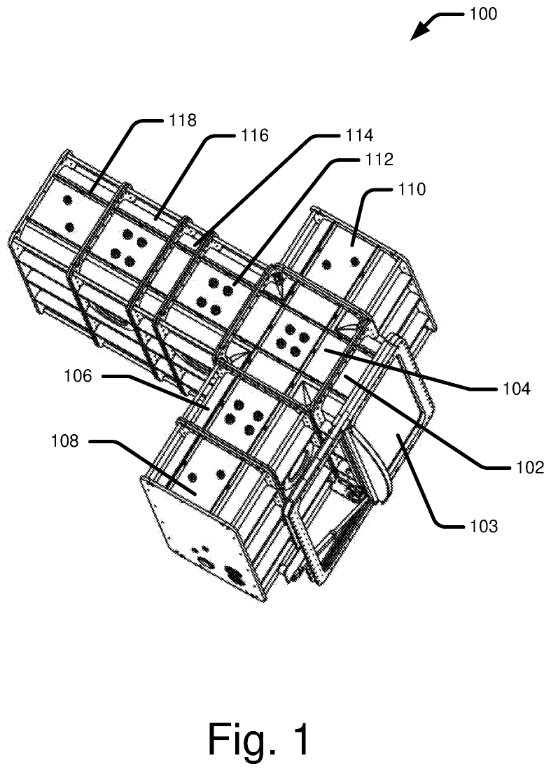

FIG. 1 illustrates a hyperbaric chamber 100, in accordance with an implementation of the present subject matter. The hyperbaric chamber 100 may be used for hyperbaric oxygen therapy for at least one patient (not shown in FIG. 1). In an example, the hyperbaric chamber 100 may include a plurality of enclosure sections assembled together in various configurations. The enclosure section may alternatively be referred to as section. The assembly of the sections may be based on the number of patients to be accommodated in the hyperbaric chamber, size of a room in which the hyperbaric chamber is to be accommodated, and the like. The plurality of sections may include a first door section 102, a first union enclosure section 104, and a plurality of end sections. The first union enclosure section 104 may be hereinafter referred to as the first union section and the end enclosure section may be referred to as end section. In an example, the cross-section of each section of the hyperbaric chamber 100 may be substantially rectangular in shape. Accordingly, the hyperbaric chamber 100 may be alternatively referred to as “rectangular hyperbaric chamber”.

In the example depicted herein, the plurality of sections may include a first seat section 106, a second seat section 112, a first spacer section 114, a third seat section 116, a first end enclosure section 108, a second end enclosure section 110, and a third end enclosure section 118. The first end enclosure section 108, the second end enclosure section 110, and the third end enclosure section 118 may be referred to as the first end section, the second end section, and the third end section respectively. Each end enclosure section 108, 110, 118 may include an end plate (not shown in FIG. 1) to form a closed chamber.

The first union section 104 may enable expansion of the hyperbaric chamber 100 and may be joined with a plurality of sections and allows for movement between the joined sections. For example, the first union section 104 may be a hollow structure and may have an opening on each of sidewalls (not shown in FIG. 1). The first union section 104 may comprise a first top wall (not shown in FIG. 1), a first bottom wall (not shown in FIG. 1), a first sidewall (not shown in FIG. 1) having a first opening, a second sidewall (not shown in FIG. 1) having a second opening, a third sidewall (not shown in FIG. 1) having a third opening, a fourth sidewall (not shown in FIG. 1) having a fourth opening. The first sidewall, the second sidewall, the third sidewall, and the fourth sidewall may be connected to the first top wall and the first bottom wall to form an open enclosure. The first union section 104 may be connectable to another section through one of the openings. The first door section 102 may be connectable to the first opening of the first union section 104. The plurality of end sections may be connectable one of directly or indirectly to each of the second opening, the third opening, and the fourth opening of the first union section. In an example, the third opening may be connectable to the first seat section 106 and the first seat section 106 may be connectable to the first end section 108. The fourth opening may be connectable to the second end section 110. The second opening may be connectable to the second seat section 112, the second seat section 112 may be connectable to the first spacer section 114, and the first spacer section 114 may be connectable to the third seat section 116. Further, the third seat section 116 may be connectable to the third end section 118. In an example, height of all the sections may be same.

The first door section 102 may include a door 103 that can be opened to allow entry and exit of persons into and out of the hyperbaric chamber 100. The door 103 may be closed when the hyperbaric chamber 100 is pressurized and when the patients are subjected to treatment, such as hyperbaric oxygen therapy. The first seat section 106 and the first end section 108 may form a seating area (not shown in FIG. 1) in which a patient (not shown in FIG. 1) can be seated. Accordingly, a seat (not shown in FIG. 1) may be accommodated by the first seat section 106 and the first end section 108. The second end section 110 may be provided facing the seating area and be used for seating an attender (not shown in FIG. 1) or a nurse (not shown in FIG. 1) who has to attend to the patient in the seating area.

As mentioned earlier, the first union section 104 may be used for joining different sections and for allowing movement between the joined sections. Therefore, the first union section 104 allows movement of persons from one section to another, such as entry of a patient into the first seat section 106 from the outside of the hyperbaric chamber 100 through the door section 102, entry of a patient into the second seat section 112 from the outside of the hyperbaric chamber 100 through the door section 102, and movement of an attender from the first seat section 106 to the second end section 110.

The second seat section 112, the first spacer section 114, the third seat section 116, and the third end section 118 may form a stretcher area, in which a stretcher (not shown in FIG. 1) can be housed. On the stretcher, a patient lying in a horizontal position can be accommodated. Thus, the hyperbaric chamber 100 can simultaneously accommodate two patients, where one patient may be in a seated position and another patient may be in a horizontal position.

The hyperbaric chamber 100 has a single area for treatment of patients, i.e., the area including the seating area formed by the first seat section 106 and the first end section 108, the second end section 110, and the union section 104. Therefore, the stretcher area in the hyperbaric chamber 100 may be referred to as a single lock system. In the hyperbaric chamber 100, when the door is closed the entire chamber is pressurized for the treatment of the patients.

In the above example, the hyperbaric chamber 100 includes a single area for treatment of patients. In some examples, the hyperbaric chamber 100 may include additional areas for treatment of patients, as will be explained below.

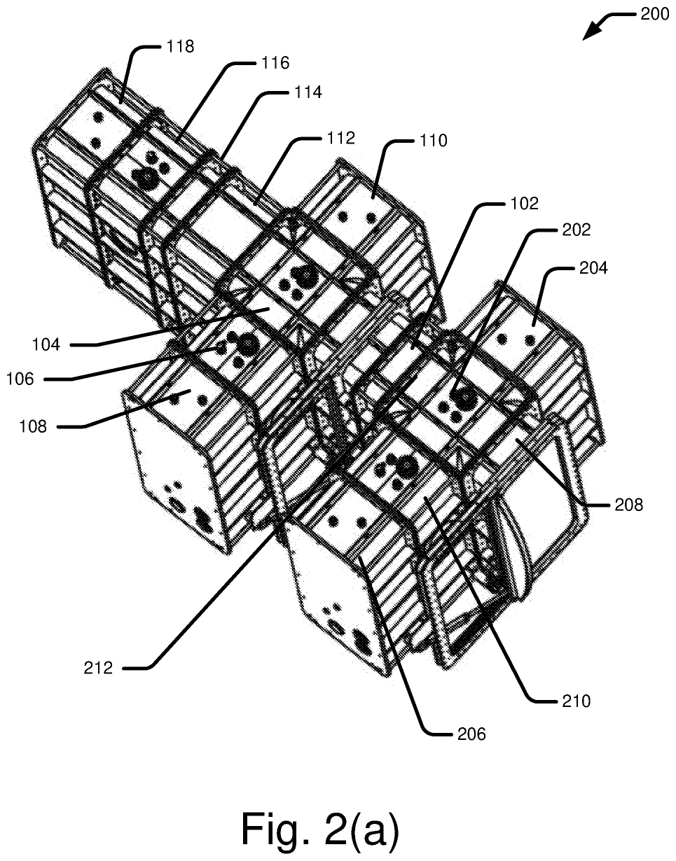

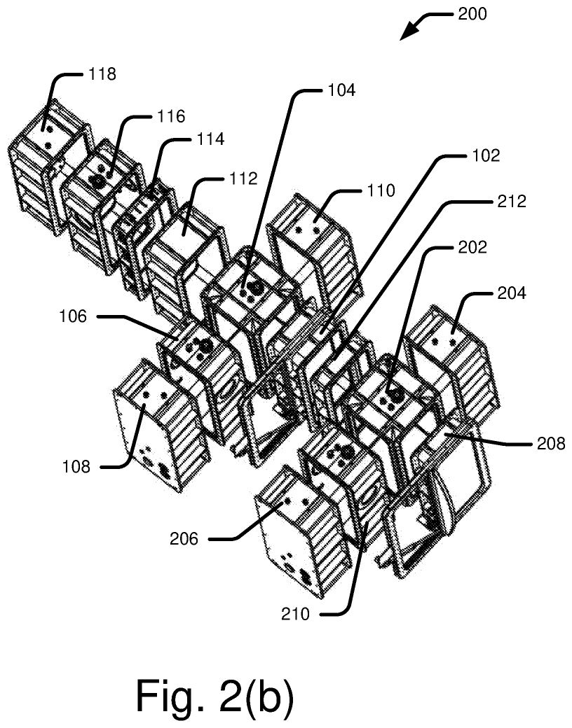

FIG. 2a illustrates a hyperbaric chamber 200, in accordance with an implementation of the present subject matter. The hyperbaric chamber 200 may include components similar to the hyperbaric chamber 100. For instance, plurality of sections of the hyperbaric chamber 200 may include the first door section 102, the first union section 104, the first seat section 106, the first end section 108, the second end section 110, the second seat section 112, the first spacer section 114, the third seat section 116, and the third end section 118. In addition, the pluralilty of sections of the hyperbaric chamber 200 may include a second union enclosure section 202, a fourth end enclosure section 204, a fifth end enclosure section 206, a second door section 208, a fourth seat section 210, and a second spacer section 212. The second union enclosure section 202 may be hereinafter referred to as the second union enclosure section. The fourth end enclosure section 204 and the fifth end enclosure section 206 may be hereinafter referred to as the fourth end enclosure section and the fifth end enclosure section.

Similar to the first union section 104, the second union section 202 may also include four sidewalls with openings in each of the wall, a top wall, and a bottom wall. For instance, the second union section 202 may include a fifth sidewall (not shown in FIG. 2a) having a fifth opening, a sixth sidewall (not shown in FIG. 2a) having a sixth opening, a seventh sidewall (not shown in FIG. 2a) having a seventh opening, an eighth sidewall (not shown in FIG. 2a) having an eighth opening, a second top wall (not shown in FIG. 2a), and a second bottom wall (not shown in FIG. 2a).

The fifth sidewall, the sixth sidewall, the seventh sidewall, and the eighth sidewall are connected to the second top wall and the second bottom wall to form an open enclosure. The fifth opening may be connectable to the second door section 208 (which allows entry into and exit from the hyperbaric chamber 200). The sixth opening may be connectable to the second spacer section 212 and the second spacer section 212 may be connectable to the first door section 102. The seventh opening may be connectable to the fourth seat section 210, the fourth seat section 210 may be connectable to the fourth end section 204. The eighth opening may be connectable to the fifth end section 206.

As illustrated, the hyperbaric chamber 200 may include an additional seating area as compared to the hyperbaric chamber 100. For example, the hyperbaric chamber 200 includes a first seating area formed by the first seat section 106 and the first end section 108 and a second seating area formed by the fourth seat section 210 and the fifth end section 206. The first seating area may include a first seat (not shown in FIG. 2a) for accommodating a patient and the second seating area may include a second seat (not shown in FIG. 2a) for accommodating a patient. In addition, similar to the hyperbaric chamber 100, the hyperbaric chamber 200 includes a stretcher area formed by the second seat section 112, the first spacer section 114, the third seat section 116, and the third end section 118 and may accommodate a stretcher (not shown in FIG. 1). Further, in the second end section 110 and the fourth end section 204, an attender or a nurse for a patient may be accommodated.

In the hyperbaric chamber 200, the first door section 102 may act as an intermediate door that connects the first union section 104 and the second union section 202. The second door section 208 includes a door (not shown in FIG. 2a) that can be closed. When the door is closed, the first seating area becomes separated from the second seating area and the stretcher area. Thus, elevated pressure can be applied in the first seating area and the stretcher area even if the door of the door section 208 is opened.

All the sections of the hyperbaric chamber 200 may have a substantially rectangular cross-section and therefore, the hyperbaric chamber 200 may also be referred to as rectangular hyperbaric chamber. Since the hyperbaric chamber 200 can be divided into two areas (by the first door section 102), the hyperbaric chamber 200 is said to be a double lock system. The double lock system allows entry and exit of persons into and out of the hyperbaric chamber 200 while the first seating area and the stretcher area are pressurized (e.g., for treatment of patients). For example, if a person seated on the first seating area is to exit the hyperbaric chamber 200, the door of the first door section 102 may be closed, thereby isolating the second seating area from the first seating area and the stretcher area. Thereafter, the second seating area may be depressurized to atmospheric pressure and the door of the second door section 208 may be opened. Similarly, if a person in the first seating area has to exit the hyperbaric chamber 200 while a person is being treated in the stretcher area, the person may move to the second union section 202 through the first door section 102 and subsequently, the door of the first door section 102 may be closed. Thereafter, the second union section 202 may be depressurized, and the door of the second door section 208 may be opened. Thus, treatment of one or more patients can continue even during movement of persons into and out of the hyperbaric chamber 200.

FIG. 2(b) illustrates an exploded view of the hyperbaric chamber 200, in accordance with an implementation of the present subject matter. As illustrated, the union sections 102 and 202 may be substantially cuboid-shaped and hollow, and may have openings on each of its sidewalls except the top and the bottom faces. Through the openings, other sections may be joined to the union section. Each seat sections may be cuboid-shaped and hollow and may have openings on two opposing faces. The end sections may also be hollow and cuboid-shaped and may have opening on one of its faces. Through the opening, the end sections may be attached to another section, such as a seat section. A spacer section may be similar in structure to the seat section and may differ from the seat section in terms of its length. The spacer section may have lesser length than the seat section. In an example, all the sections of the hyperbaric chamber 200 may be of same height.

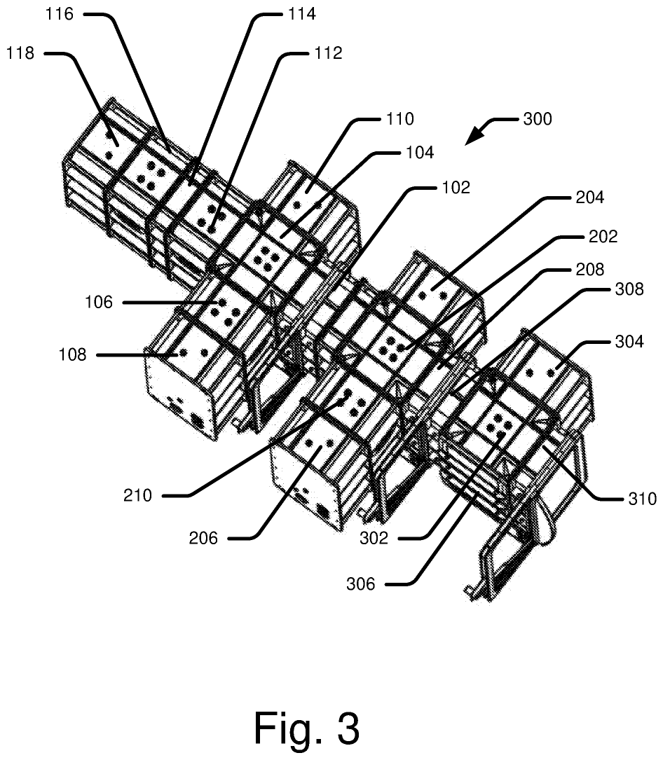

FIG. 3 illustrates a hyperbaric chamber 300, in accordance with an implementation of the present subject matter. The hyperbaric chamber 300 may be similar to the hyperbaric chamber 200. The hyperbaric chamber 300 may include the plurality of sections similar to the hyperbaric chamber 200. In addition, the hyperbaric chamber 300 may include the plurality of sections having a third union enclosure section 302, a sixth end enclosure section 304, an end plate 306, a third spacer section 308, and a third door section 310. The third union enclosure section 302 may be hereinafter referred to as the third union section and the sixth end enclosure section 304 may be hereinafter referred to as the sixth end section.

Similar to the first union section 102 and the second union section 202, the third union section 302 may include sidewalls, a top wall, and a bottom wall. For instance, the third union section 302 may include a ninth sidewall (not shown in FIG. 3) having a ninth opening, a tenth sidewall (not shown in FIG. 3) having a tenth opening, an eleventh sidewall (not shown in FIG. 3) having an eleventh opening, a twelfth sidewall (not shown in FIG. 3) having a twelfth opening, a third top wall (not shown in FIG. 3), and a third bottom wall (not shown in FIG. 3). The ninth sidewall, the tenth sidewall, the eleventh sidewall, and the twelfth sidewall may be connected to the third top wall and the third bottom wall to form an open enclosure.

The hyperbaric chamber 300 may include an additional area, such as for accommodating an attender for a patient or a nurse, as compared to the hyperbaric chamber 100. For example, the hyperbaric chamber 300 may include the first seating area formed by the first seat section 106 and the first end section 108, the stretcher area formed by the second seat section 112, the first spacer section 114, the third seat section 116, and the third end section 118, the second seating area formed by the fourth seat section 210 and the fifth end section 206. A first personnel, such as an attender for a patient or a nurse, may be accommodated in the fourth end section 204 and a second personnel, such as an attender or a nurse, may be accommodated in the sixth end section 304.

In the hyperbaric chamber 300, the first door section 102 may act as an intermediate door that connects the first union section 104 and the second union section 202. Further, the second door section 208 may act as an intermediate door that connects the second union section 202 and the third union section 302. The third door section 310 may enable entry and exit of persons from the hyperbaric chamber 300. When the door of the first door section 102 is closed, the first seating area becomes separated from the second seating area and the stretcher area. Similarly, when the door of the second door section 208 is closed, the second seating area becomes separated from the third union section 302.

In an example, all the sections of the hyperbaric chamber 300 may be of identical height. All the section of the hyperbaric chamber 300 may have a substantially rectangular in cross-section and therefore, the hyperbaric chamber 300 may also be referred to as rectangular hyperbaric chamber.

By providing two intermediate door sections in the hyperbaric chamber 300, the hyperbaric chamber 300 is divided into three areas: (i) a first area including the stretcher area, the first seating area, the first union section 104, and the second end section 110 (ii) a second area including the second seating area, the second union section 202, and the fourth end section 204, and (iii) a third area including the third union section 302 and the sixth end section 304. Accordingly, the hyperbaric chamber 300 is also referred to as a triple lock system. The triple lock system can be used for treating critical patients in a separate area, such as the first area, while the other patients can be treated in another area, such as the second area.

In the hyperbaric chambers 100, 200, 300, the first seat section 106 is explained to be connectable with first end section 108 to accommodate a first seat for a patient. However, in other examples, the hyperbaric chambers 100, 200, 300, the first seat section 106 may be connectable with a fourth spacer section, and the fourth spacer section may be connectable with the first end section 108. Further, a seat, which may be reclinable, may be accommodated by first seat section 106, the first end section 108, and the fourth spacer section.

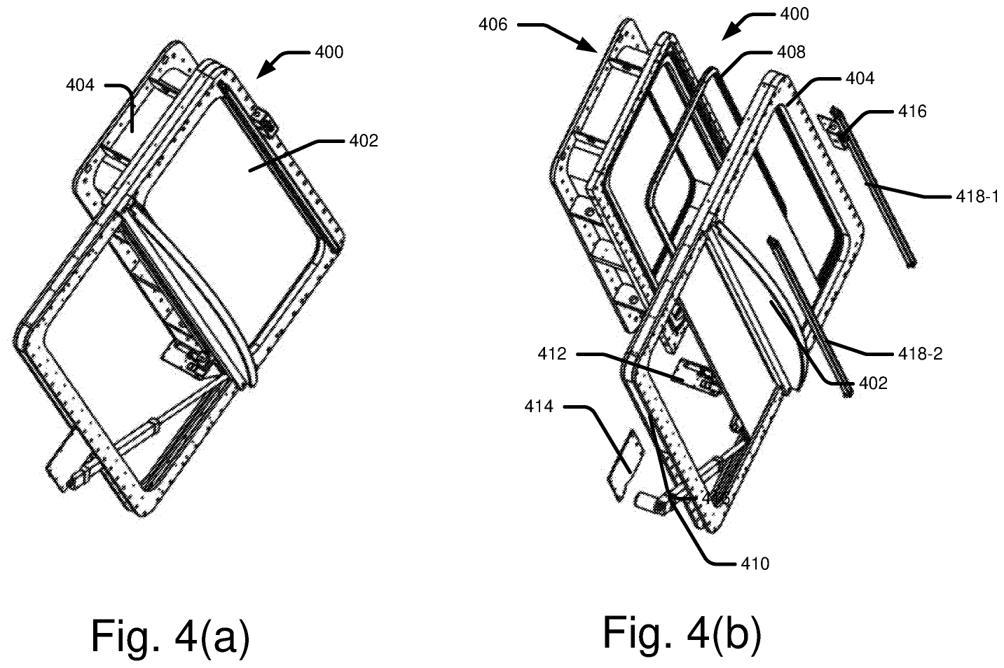

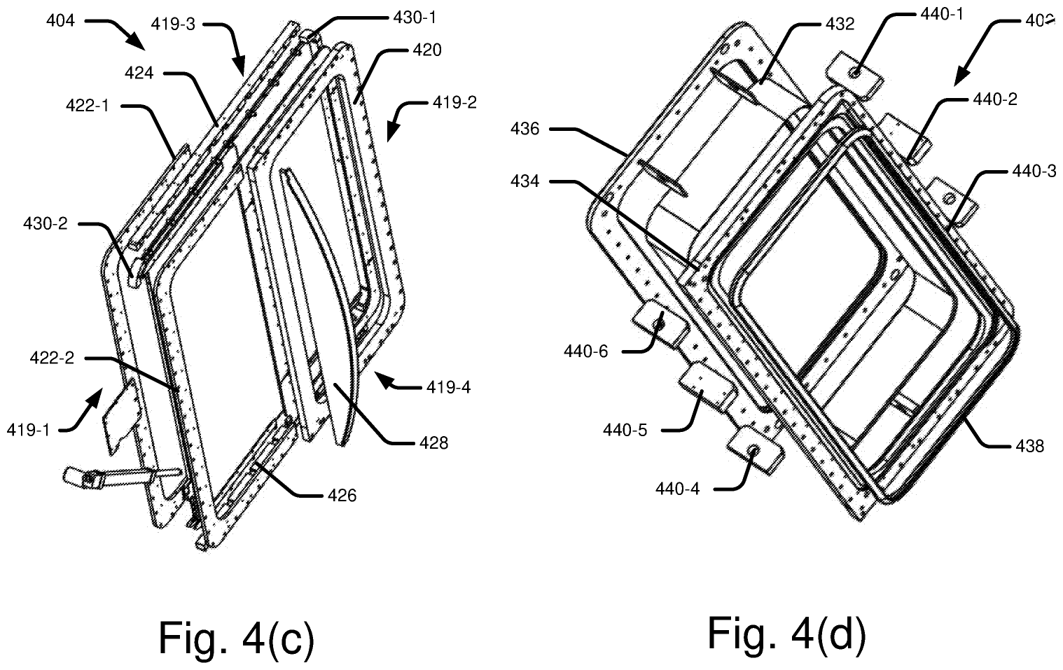

FIG. 4(a) illustrates a door section 400, in accordance with an implementation of the present subject matter. The door section 400 may correspond to the first door section 102, the second door section 208, or the third door section 310. The door section 400 includes a door 402 that can slide on a door frame 404 for opening and closing of a hyperbaric chamber to which the door section 400 is attached. For instance, the door 402 may be enclosed in and supported by the door frame 404. The provision of a sliding door, instead of doors that open internally or externally, saves space occupied by the door when it is in the open position. Further, the door 402 is externally sealing, and therefore, the door 402 does not consume any space within the hyperbaric chamber 400. The door section 400 may be coupled to a union section or to a seat section.

FIG. 4(b) illustrates an exploded view of the door section 400, in accordance with an implementation of the present subject matter. The door section 400 includes a door shell assembly 406, in addition to the door 402 and the door frame 404. The door shell assembly 406 may be coupled to the door frame 404 and may provide structural support the door section 400. A skirt seal 408 may be disposed between the door shell assembly 406 and the door frame 404. The skirt seal 408 may provide a sealing enclosure to the coupling between the door frame 404 and the door shell assembly 406. The skirt seal 408 expands under pressure when the hyperbaric chamber is pressurised, to increase the seal capability. Thus, as the pressure inside the hyperbaric chamber increases, so does the sealing capability.

The sliding of the door 402 in the door frame 404 is achieved using an actuator 410 coupled to the door frame 404 and to the door 402. The actuator 410 may be, for example, an electrical actuator or a pneumatic actuator. A door lock assembly 412 may be used to maintain the door 402 at a locked position. A door actuator bracket 414 may be used for holding a pneumatic cylinder which is used for opening and closing the door 402. The actuating of the door 402 may be performed in response to pressing of a door switch 416, for example, by both the attender inside and a trained professional outside as a safety redundancy. The door section 400 also includes a pair of door safety light curtains, such as a first safety light curtain 418-1 and a second safety light curtain 418-2 to prevent the door 402 from closing in the event of personnel in the path of the door 402. In an example, the first safety light curtain 418-1 and the second safety light curtain 418-2 may be coupled to the door frame 404.

FIG. 4(c) illustrates an exploded view of the door frame 404, in accordance with an implementation of the present subject matter. The door frame 404 may include a first end 419-1, a second end 419-2, a third end 419-3, and a fourth end 419-4. The first end 419-1 may be opposite the second end 419-2 and the third end 419-3 may be opposite the fourth end 419-4. The door frame 404 may enclose the door 402 and support the door 402. The door 402 may be slidable from the first end 419-1 to the second end 419-2 to prevent entry and exit of persons into and outside of the hyperbaric chamber.

The door frame 404 includes a door flange 420 and a pair of door support flanges, such as a first door support flange 422-1 and a second door support flange 422-2 for supporting the door 402. The door frame 404 also includes a first guideway block 424 provided at the third end 419-3 between the first door support flange 422-1 and the second door support flange 422-2. A second guideway block 426 may be provided at the fourth end 419-4 between the first door support flange 422-1 and the second door support flange 422-2. The first guideway block 424 and the second guideway block 426 may support the sliding of the door 402. A beam weld assembly 428 is to help with manual opening and closing of the door 402. Guideway corners 430-1, 430-2 enable stopping the sliding movement of the door 402 when the door reaches an end of the door frame 404.

FIG. 4(d) illustrates an exploded view of the door shell assembly 406, in accordance with an implementation of the present subject matter. The door shell assembly 406 includes a door shell 432. The door shell 432 is hollow and is substantially cuboid-shaped. Further, two opposing faces of the door shell 432 are kept open. A head flange 434 is attached to one end of the door shell 432 and a tail flange 436 is attached to another end of the door shell 432 to provide rigidity to the door shell assembly 406. The head flange 434 and the tail flange 436 may be hollow and rectangular-shaped. A skirt seal 438 is joined to the head flange 434. The skirt seal 438 enables joining the door shell assembly 406 to the door frame 404. The door shell assembly 406 further includes a plurality of door ribs 440-1-440-6 connected to the door shell 432 to enhance the structural rigidity of the door shell assembly 406.

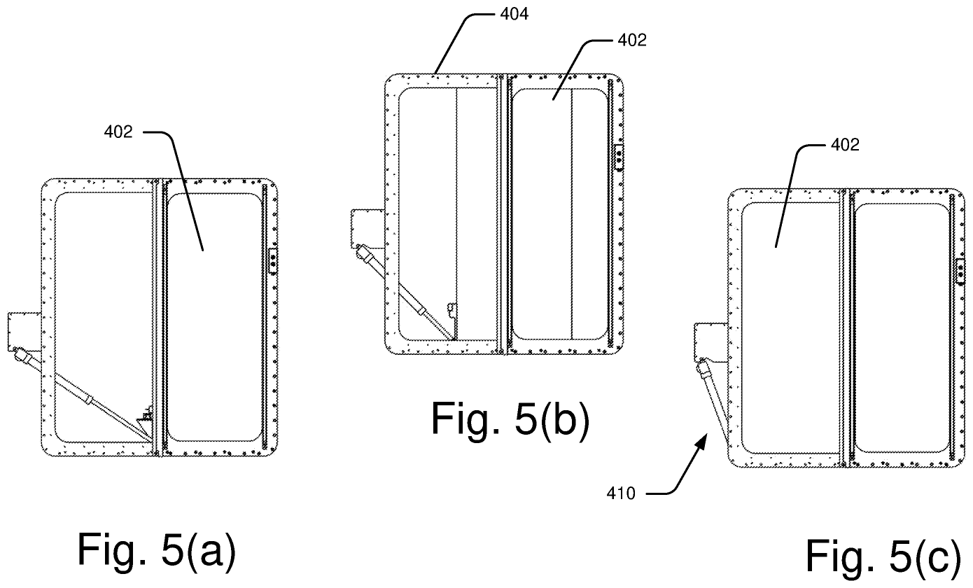

FIGS. 5(a), 5(b), and 5(c) illustrate closed, partially open, and open positions, respectively, of the door 402, in accordance with an implementation of the present subject matter. The door 402 undergoes a sliding motion on the door frame 404 and is moved by the electrical actuator assembly 410.

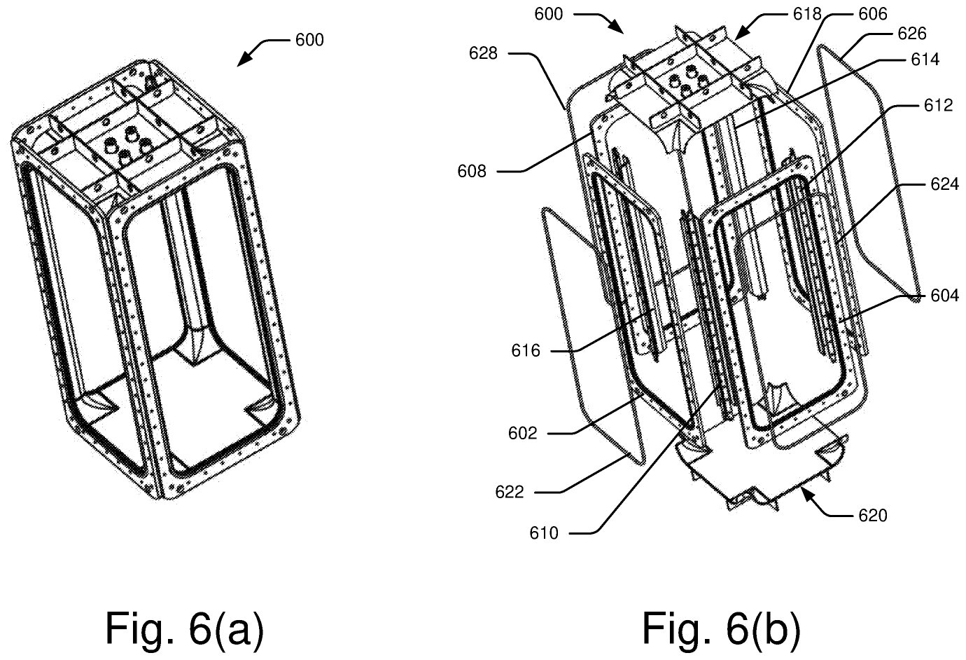

FIG. 6(a) illustrates a union enclosure section 600, in accordance with an implementation of the present subject matter. The union enclosure section 600 may be hereinafter referred to as the union section. The union section 600 may correspond to the first union section 104, the second union section 202, or the third union section 302. As illustrated, the union section 600 is substantially cuboid-shaped and is hollow. All faces of the union section 600 except the top and the bottom faces have an opening. As will be understood, dimensions of an opening of a section to which an opening of the union section 600 is to be joined may be same as that of the opening of the union section 600. In an example, height of the union section 600 may be from 1813 mm to 2134 mm, width of the union section 600 may be from 695 mm to 1067 mm, and length of the union section 600 may be from 911 mm to 1378 mm.

FIG. 6(b) illustrates an exploded view of the union section 600, in accordance with an implementation of the present subject matter. The union section 600 includes four sidewalls, such as a first sidewall 602, a second sidewall 604, a third sidewall 606, and a fourth sidewall 608 that are substantially rectangular in shape. Each sidewall is joined to two other sidewalls at two of its opposing edges such that the two sidewalls are perpendicular to the sidewall. In this manner, a hollow structure is formed that is open at its top and bottom. To facilitate this arrangement, each sidewall is joined to another sidewall through a bracket. Accordingly, the union section 600 may include four brackets, such as a first bracket 610, a second bracket 612, a third bracket 614, and a fourth bracket 616 The first bracket 610, the second bracket 612, the third bracket 614, and the fourth bracket 616 may be L-shaped. In an example, the first bracket 610 is disposed and coupled to the first sidewall 602 and the second sidewall 604. The second bracket 612 may be coupled to the second sidewall 604 and the third sidewall 606. The third bracket 614 may be disposed between and coupled to the third sidewall 606 and the fourth sidewall 608. The fourth bracket 616 may be disposed between and coupled to the fourth sidewall 608 and the first sidewall 602. The brackets 610-616 may be joined to the frames by welding.

A top wall 618 is assembled at the top of the hollow structure and a bottom wall 620 is assembled at the bottom of the hollow structure. The brackets 610-616 may be disposed between and coupled to the top wall 618 and the bottom wall 620. The union section 600 also includes four O-rings 622, 624, 626, and 628 having dimensions corresponding to the frame. Each O-ring is connected to one frame, as illustrated. The O-rings 622, 624, 626, and 628 enable connection of their respective frames to another section of a hyperbaric chamber. The O-rings may be, for example, nitrile O-rings.

The union section 600 can be used for expanding the size of the hyperbaric chamber in any direction, as a section to be installed, such as a seat section, an end section, a door section, can be joined one of the open walls of the union section. The union section 600 enables making the hyperbaric chamber a modular and an expandable structure.

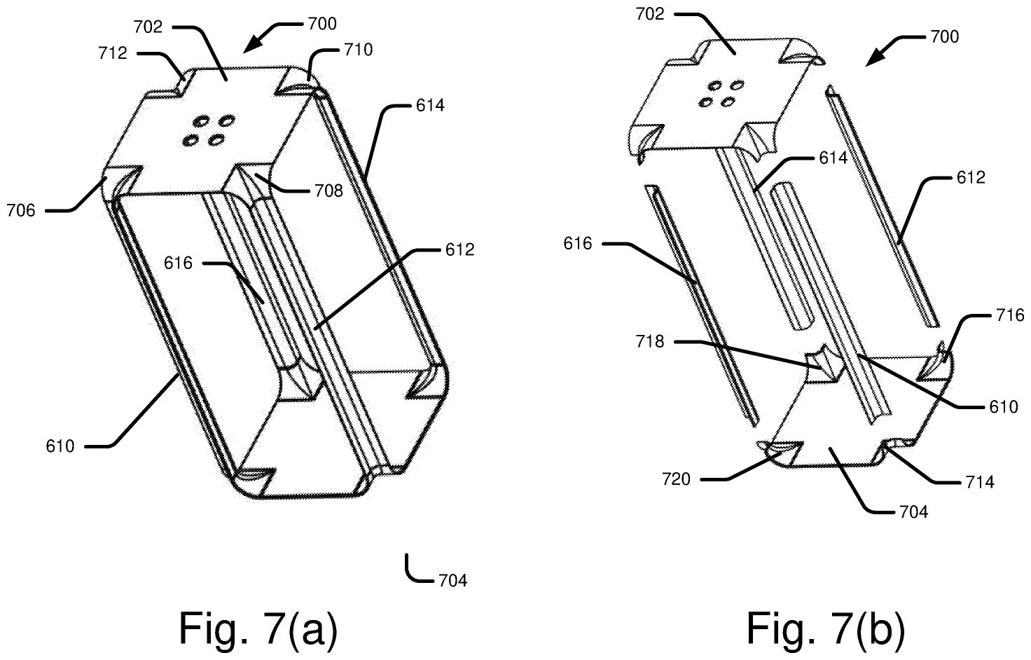

FIGS. 7(a) and 7(b) illustrate assembled and exploded views, respectively, of a shell 700 of the union section 600, in accordance with an implementation of the present subject matter. The shell 700 includes the brackets 610-616, a top sheet 702 of the top wall 618, and a bottom sheet 704 of the bottom wall 620. In an example, the top sheet 702 and the bottom sheet 704 may be rectangular shaped with square cut corners. Further, the top sheet 702 may include a first joint 706, a second joint 708, a third joint 710, and a fourth joint 712. Each joint may be disposed at a corner of the top sheet 702. The joints 706-712 may be coupled to the brackets 610-616 to enable coupling of the brackets 610-616 with the top wall 618. For instance, the first joint 706 may be coupled to the first bracket 610. The second joint 708 may be coupled to the second bracket 612. The third joint 710 may be coupled to the third bracket 614. The fourth joint 712 may be coupled to the fourth bracket 616. Similarly, the bottom sheet 704 may include a fifth joint 714, a sixth joint 716, a seventh joint 718, and an eighth joint 720 to join the brackets 610-616 with the bottom wall 620. Each joint may be disposed at a corner of the bottom sheet 704. The joints 714-720 may be coupled to the brackets 608-616. For instance, the fifth joint 714 may be coupled to the first bracket 610. The sixth joint 716 may be coupled to the second bracket 612. The seventh joint 718 may be coupled to the third bracket 614. The eighth joint 720 may be coupled to the fourth bracket 616. The joints may be coupled to the top sheet 702 or the bottom sheet 704 and to the brackets 610-616 by welding.

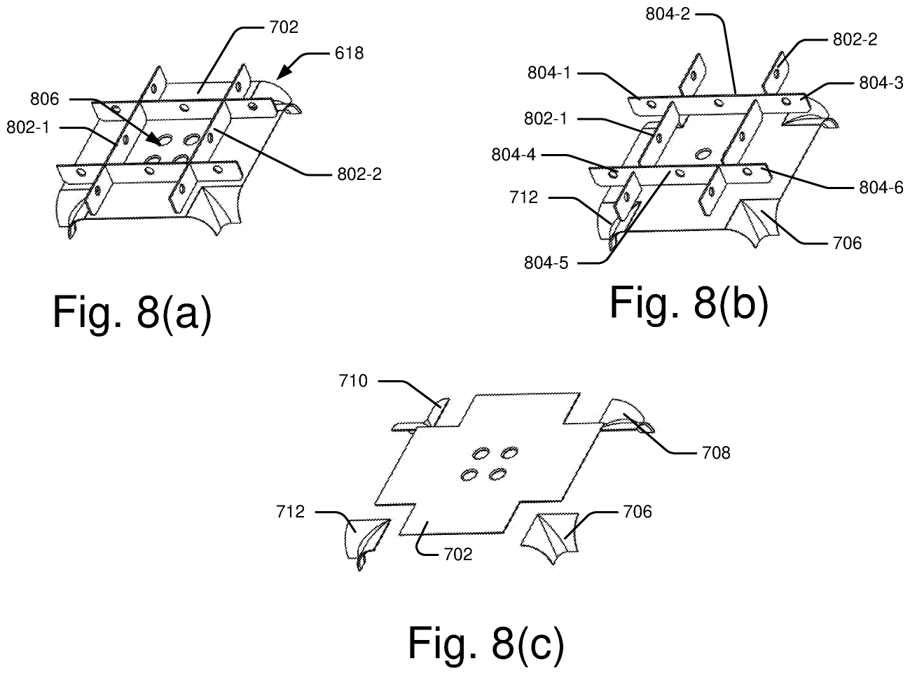

FIGS. 8(a)-8(c) illustrate assembled and exploded views of the top wall 618 of the union section 600, in accordance with an implementation of the present subject matter. As explained earlier, the top wall 618 includes the top sheet 702 and the joints 706-712. Further, the top wall 618 includes a first plurality of ribs 802-1, 802-2 and a second plurality of ribs 804-1-804-6 disposed on the top sheet 702. The first plurality of ribs 802 includes ribs that are parallel to each other and that are perpendicular to the ribs of the second plurality of ribs 804-1-804-6. A rib of the second plurality of ribs 804 is perpendicular to and attached to at least one rib of the first plurality of ribs 802. Accordingly, the first plurality of ribs 802 and of the second plurality of ribs 804 criss-cross the area of the top sheet 702, thereby increasing structural rigidity of the top wall 618. The top sheet 702 also includes openings 806 through which electrical wiring for lighting devices (not shown in FIG. 8) of the union section 600 can be provided.

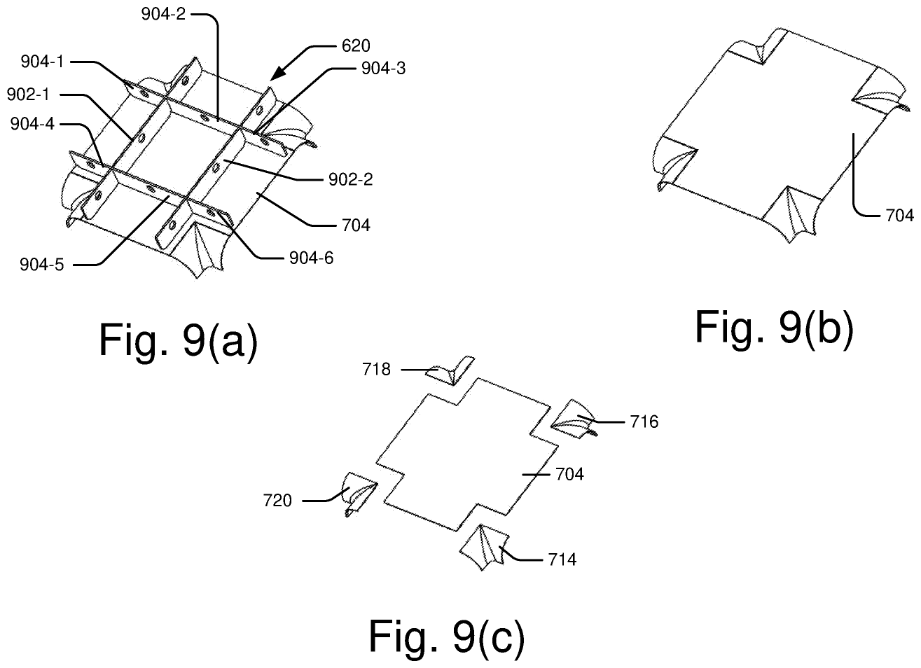

FIGS. 9(a)-9(c) illustrate assembled and exploded views of the bottom wall 620, in accordance with an implementation of the present subject matter. As explained earlier, the bottom wall 620 includes the bottom sheet 704 and the joints 714-720. Further, the bottom wall 620 includes a third plurality of ribs 902-1, 902-2 and a fourth plurality of ribs 904-1-904-6 that are connected to the bottom sheet 704.

The third plurality of rib plates 902-1, 902-2 are perpendicular to the fourth plurality of ribs 904-1-904-6. A rib of the third plurality of ribs 902 is perpendicular to and attached to at least one rib of the fourth plurality of ribs 904. Accordingly, the third plurality of ribs 902 and the fourth plurality of ribs 904 criss-cross the area of the bottom sheet 704, thereby increasing structural rigidity of the bottom wall 620.

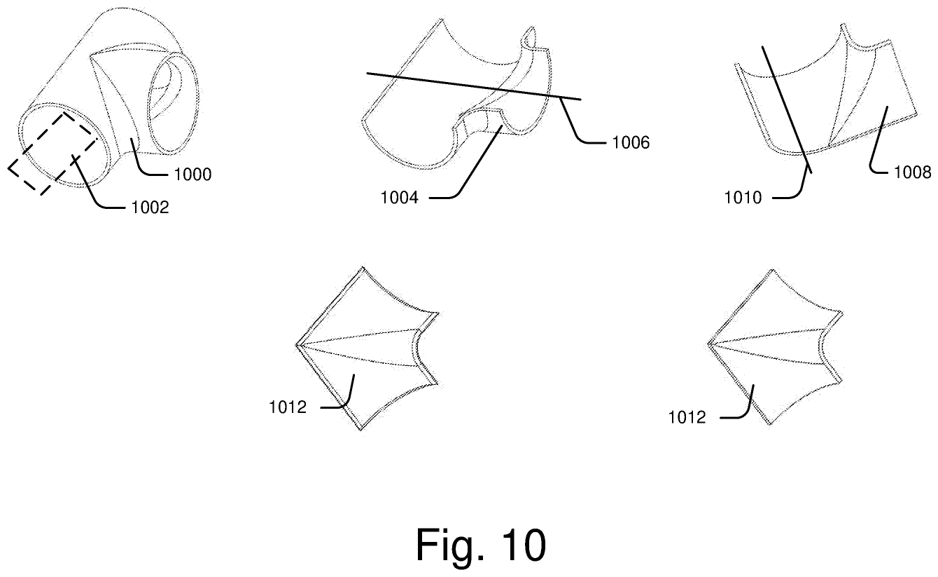

FIG. 10 illustrates the formation of a joint that connects the top wall 618 or the bottom wall 620 of the union section 600 with a bracket of the union section 600, in accordance with an implementation of the present subject matter. The joint can be formed from a T-joint 1000. The T-joint 1000 may be divided into two halves by cutting it along a plane 1002. A T-half 1004 formed by cutting the T-joint 1000 may be further divided into two halves by cutting it along a line 1006. A T-quarter 1008 obtained by cutting the T-half 1004 may be cut along the line 1010 to form the joint 1012. The joint 1012 may be of hyperbolic-paraboloid shape. The joint 1012 may correspond to the first joint 706, the second joint 708, the third joint 710, the fourth joint 712, the fifth joint 714, the sixth joint 716, the seventh joint 718, and the eighth joint 720.

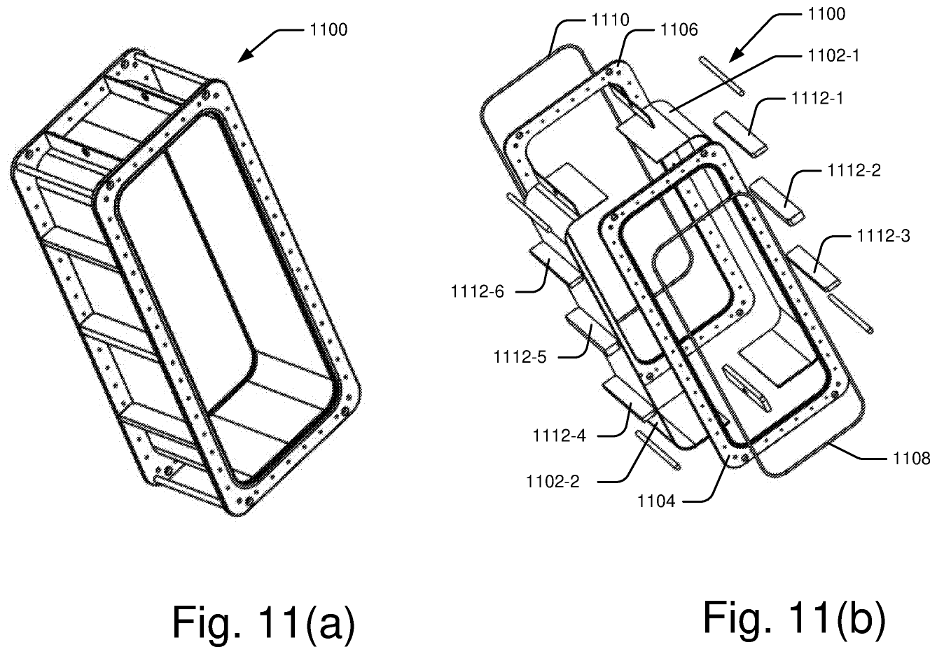

FIG. 11(a) illustrates a seat section 1100, in accordance with an implementation of the present subject matter. The seat section 1100 may correspond to the first seat section 106, the second seat section 112, the third seat section 116, and the fourth seat section 210. As explained earlier, the seat section 1100 can be used for housing a part of a seat (not shown in FIG. 11(a)) or a stretcher (not shown in FIG. 11(a)). In an example, height of the seat section 1100 may be from 1813 mm to 2134 mm, width of the seat section 1100 may be from 695 mm to 1067 mm, and length of the seat section 1100 may be 570 mm.

FIG. 11(b) illustrates an exploded view of the seat section 1100, in accordance with an implementation of the present subject matter. The seat section 1100 includes a seat section shell 1102 having two halves (1102-1 and 1102-2). The two halves 1102-1, 1102-2 may be welded together to form the seat section shell 1102. One side of the seat section shell 1102 is connected to a first frame 1104 and the opposite side of the seat section shell 1102 is connected to a second frame 1106. Therefore, the second frame 1106 may be displaced at a distance from the first frame 1104. A first seal 1108, such as an O-ring, is disposed on the first frame 1104 and a second seal 1110, such as an O-ring, is disposed on the second frame 1106, to enable connection of the seat section 1100 to other sections and to provide a sealing enclosure between the coupling of the seat section 1100 to other sections. A plurality of door ribs 1112-1-1112-6 are connected to the seat section shell 1102 to improve the structural rigidity of the seat section 1100. Each of the plurality of door ribs 1112-1-1112-6 may be displaced at a distance from each other and may extend from the first frame 1104 to the second frame 1106 on the seat section shell 1102.

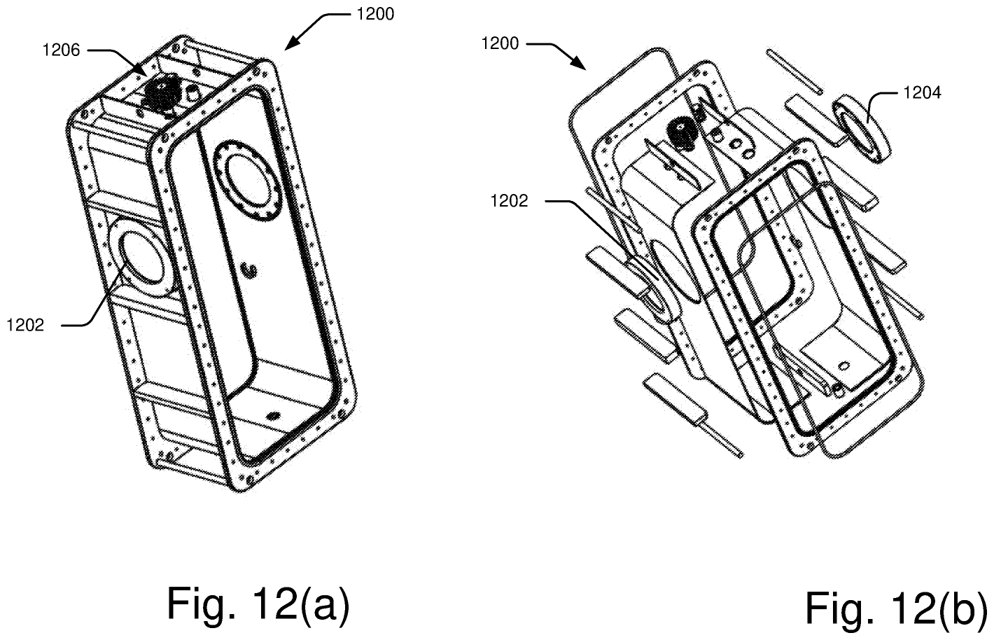

FIGS. 12(a) and 12(b) illustrate an assembled and an exploded view, respectively, of a seat section 1200, in accordance with an implementation of the present subject matter. The seat section 1200 is similar to the seat section 1100 but includes additional components. For instance, the seat section 1200 includes a first viewport 1202 and a second viewport 1204 that enable viewing of the interior of the hyperbaric chamber from the outside and vice-versa. The first viewport 1202 and the second viewport 1204 may be provided on the lateral faces of the seat section shell 1102. The seat section 1200 also includes a lighting assembly 1206 that can be used for illuminating the interior of the hyperbaric chamber. The seat section 1200 may also include a drain hole (not shown in FIGS. 12(a) and 12(b)) at its bottom for draining out liquids out of the hyperbaric chamber. The seat section 1200 may be referred to as the penetrator seat section.

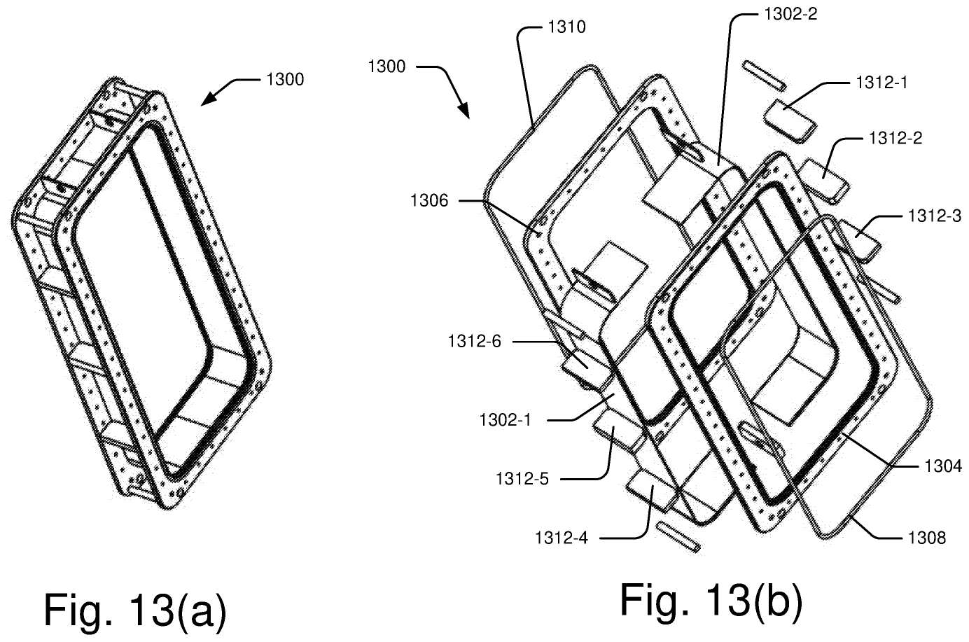

FIGS. 13(a) and 13(b) illustrate an assembled view and an exploded view, respectively, of a spacer section 1300, in accordance with an implementation of the present subject matter. The spacer section 1300 may be added as part of a seating area to increase the length of the seating area. Similarly, the spacer section 1300 may be added as part of a stretcher area to ensure that the stretcher area has sufficient length to accommodate a stretcher.

The spacer section 1300 may be similar to the seat section 1100 in terms of the constituent components and their arrangements. For example, the spacer section 1300 includes a spacer section shell 1302 formed by two halves, a front frame 1304, a rear frame 1306, a front O-ring 1308, a rear O-ring 1310, and a plurality of spacer section ribs 1312-1-1312-6. However, the spacer section 1300 has a smaller length than the seat section 1100. In an example, height of the spacer section 1300 may be from 1813 mm to 2134 mm, length of the spacer section 1300 may be 246 mm, and the width of the spacer section 1300 may be from 695 mm to 1067 mm.

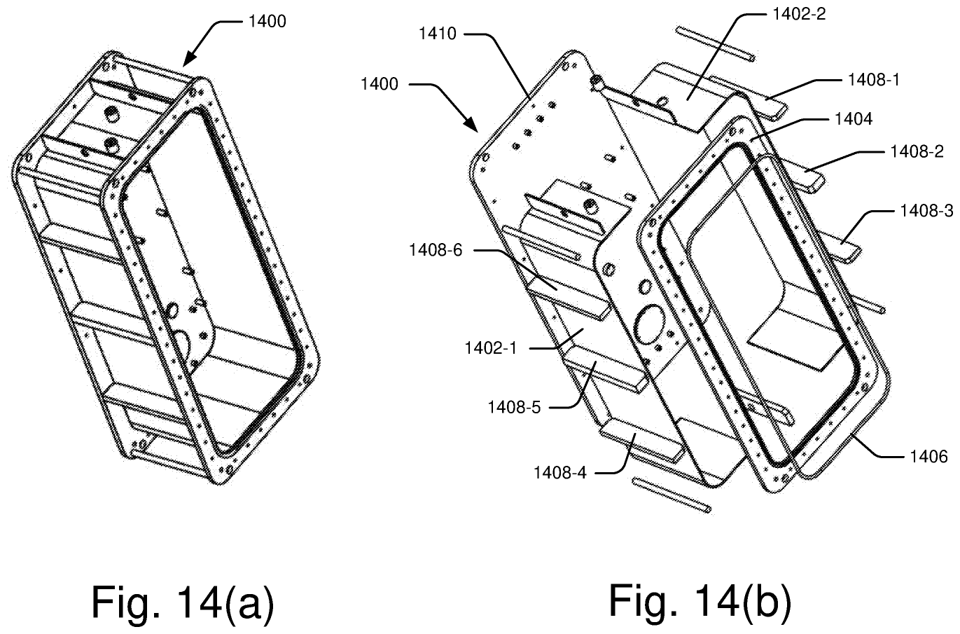

FIGS. 14(a) and 14(b) illustrate an assembled view and an exploded view, respectively, of an end enclosure section 1400, in accordance with an implementation of the present subject matter. The end enclosure section 1400 may be hereinafter referred to as the end section. The end section 1400 may correspond to the end sections 108, 110,118, 204, 206, 304. The end section 1400 includes an end section shell 1402 formed by two halves. The end section shell 1402 may be hollow and may be cuboid-shaped. An end section front frame 1404 may be attached to the end section shell 1402. The end section front frame 1404 is hollow and is rectangular-shaped. A front O-ring 1406 may be disposed on the front frame 1404. The end section 1400 may include a plurality of end section ribs 1408-1-1408-6, similar to the seat sections and the spacer section. Each of the plurality of end section ribs 1408-1-1408-6 may be spaced at a distance from each other. A rear opening of the end section shell 1402, i.e., the opening opposite the opening to which the front frame 1404 is connected, is closed using an end plate 1410. Therefore, the end plate 1410 may be disposed at a distance from the end section front frame 1404. The end plate 1410 may be attached, for example, welded, to the end section shell 1402. The end plate 1410 may be solid and rectangular-shaped. In an example, height of the end section 1400 may be of 1813 mm to 2134 mm, width of the end section 1400 may be 695 mm to 1067 mm, and the length of the end section 1400 may be 544 mm. The plurality of end section ribs 1408-1-1408-6 may extend from the end plate 1410 to end section front frame 1404 on the end section shell 1402 and may enhance the strength of the end section 1400.

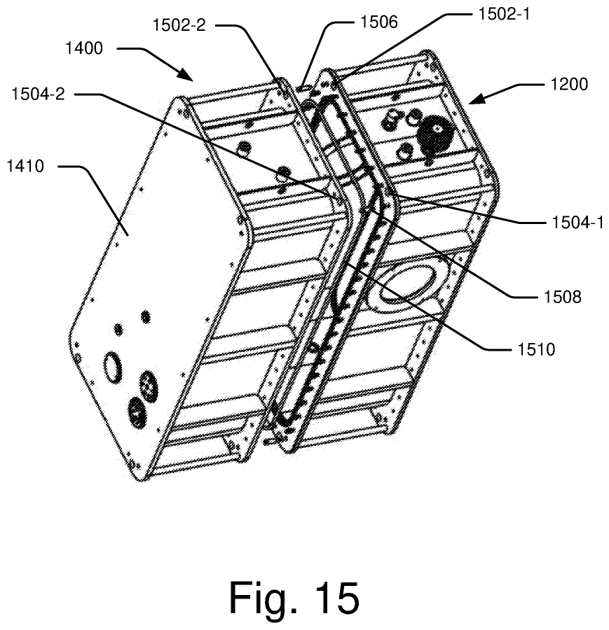

FIG. 15 illustrates assembly of the seat section 1200 and the end section 1400, in accordance with an implementation of the present subject matter. As illustrated, the seat section 1200 and the end section 1400 have identical heights, which enables the two sections to be coupled to each other at their respective top and bottom ends. The seat section 1200 and the end section 1400 each have openings that align with each other when the two sections are aligned with respect to each other. For example, an opening 1502-1 of the seat section 1200 aligns with an opening 1502-2 of the end section 1400 and an opening 1504-1 of the seat section 1200 aligns with an opening 1504-2 of the end section 1400. Through the aligned openings, a fastener, such as a fastener 1506 and a fastener 1508, may be inserted to bolt the two sections. The fasteners 1506 and 1508 may be, for example, dowel screws. In an example, a total of 42 bolts may be used for assembling two sections. The fasteners other than the ones on the corners may be, for example, Allen cap screws.

An O-ring 1510, such as a nitrile O-ring, may be used for sealing the gap between the seat section 1200 and the end section 1400 upon their assembly.

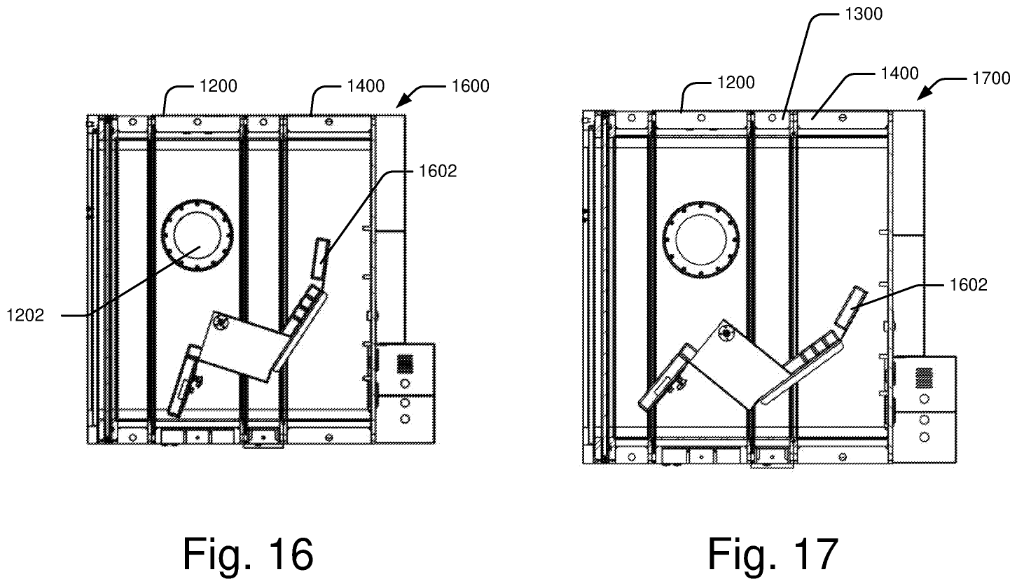

FIG. 16 illustrates a seating area 1600, in accordance with an implementation of the present subject matter. The seating area 1600 is formed by joining the seat section 1200 and the end section 1400 in the manner as illustrated in FIG. 15. Inside the seating area 1600, a seat 1602 may be disposed. The seat 1602 may be used for seating a patient (not shown in FIG. 16) who is to undergo treatment. As illustrated, the seat section 1200 includes the first viewport 1202 through which the outside of the hyperbaric chamber can be viewed by the patient.

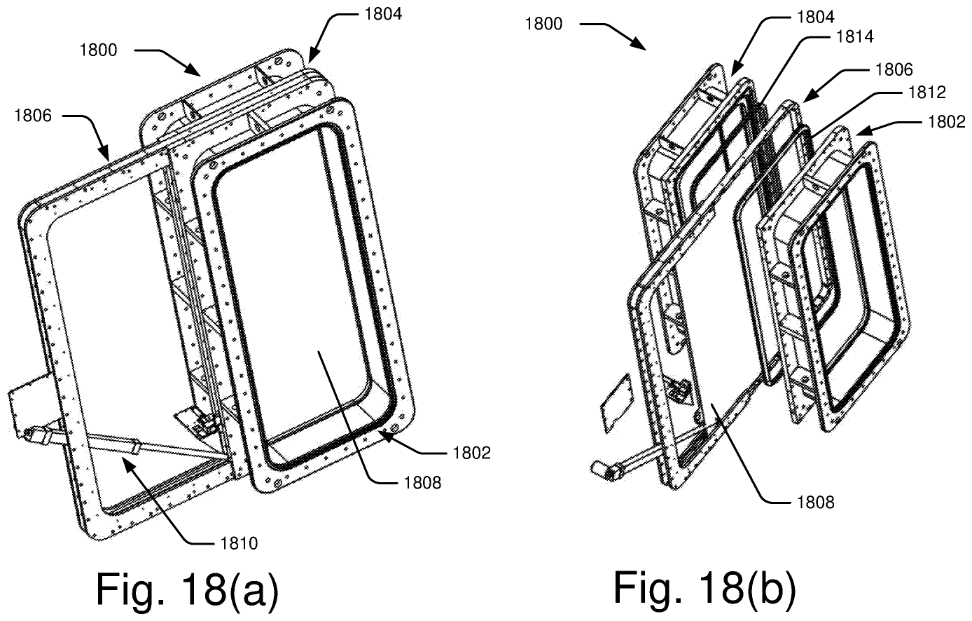

FIG. 17 illustrates a seating area 1700, in accordance with an implementation of the present subject matter. The seating area 1700 includes the spacer section 1300 interposed between the seat section 1200 and the end section 1400. Accordingly, the seating area 1700 has additional length as compared to the seating area 1600. The increased length provides additional leg space for a patient (not shown in FIG. 17) and also allows reclining of the seat 1602.

FIG. 18(a) illustrates an intermediate door section 1800, in accordance with an implementation of the present subject matter. The intermediate door section 1800 may correspond to the door section 102 in the hyperbaric chamber 200 and hyperbaric chamber 300 and the door section 208 in the hyperbaric chamber 300. The intermediate door section 1800 includes a front door shell assembly 1802 and a rear door shell assembly 1804 that are coupled to a door frame 1806. The door frame 1806 includes a sliding area in which a door 1808 can slide. An electrical actuator assembly 1810 can be used for the sliding of the door 1808. The front door shell assembly 1802 may be used to couple the intermediate door section 1800 with one union section and the rear door shell assembly 1804 may be used to couple the intermediate door section 1800 with another union section.

FIG. 18(b) illustrates an exploded view of the intermediate door section 1800, in accordance with an implementation of the present subject matter. A front skirt seal 1812 may be provided between the door frame 1806 and the front door shell assembly 1802. Similarly, a rear skirt seal 1814 may be provided between the door frame 1806 and the rear door shell assembly 1804.

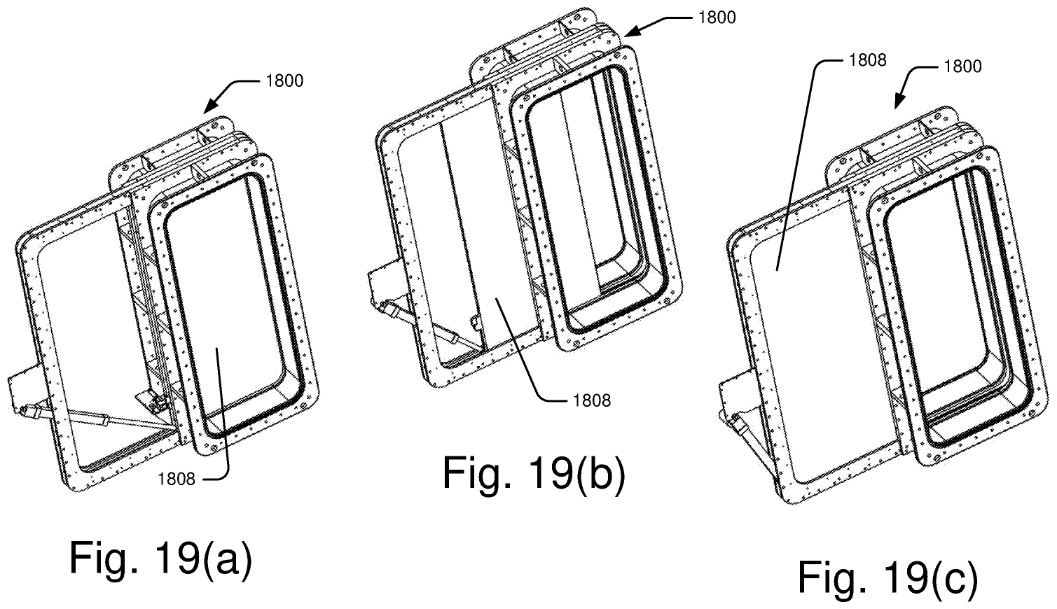

FIGS. 19(a), 19(b), and 19(c) illustrate closed, partially open, and open positions of the door 1808 of the intermediate door section 1800, in accordance with an implementation of the present subject matter.

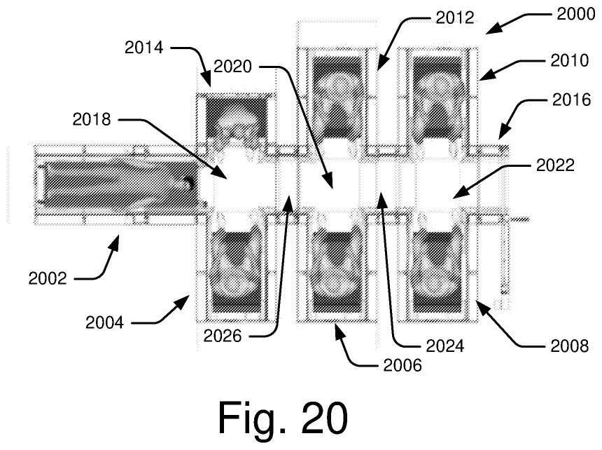

FIG. 20 illustrates a top view of a hyperbaric chamber 2000, in accordance with an implementation of the present subject matter. As illustrated, the hyperbaric chamber 2000 includes a stretcher area 2002 that is formed by two seat sections, one spacer section, and one end section. The hyperbaric chamber 2000 also includes five seat sections 2004-2012 that are each formed by one seat section and one end section. The hyperbaric chamber 2000 further includes a waiting area 2014 formed by one end section. A door section 2016 allows entry into and exit from the hyperbaric chamber 2000.

The hyperbaric chamber 2000 further includes union sections 2018-2022 for connecting the various other sections of the hyperbaric chamber 2000. The hyperbaric chamber 2000 further includes spacer sections 2024-2026 for connecting one union section with another union section.

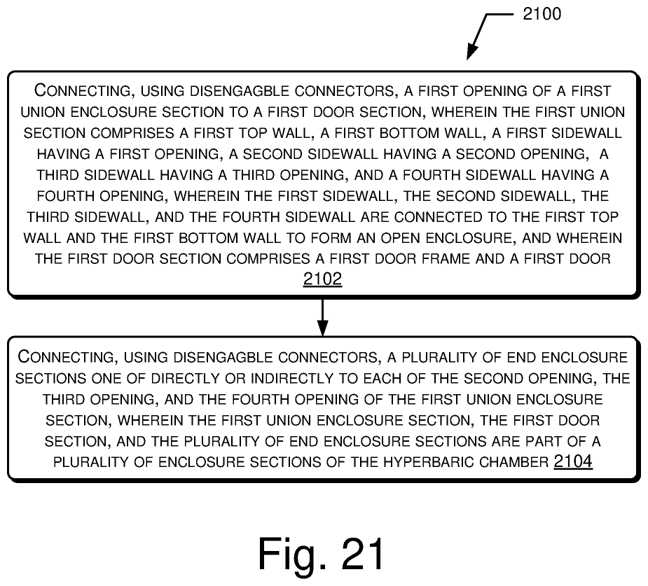

FIG. 21 illustrates a method 2100 of assembling a hyperbaric chamber, in accordance with an implementation of the present subject matter. The order in which the method 2100 is described is not intended to be construed as a limitation, and any number of the described method blocks may be combined in any order to implement the method 2100 or an alternative method. Furthermore, the method 2100 may be implemented by processor(s) or computing device(s) through any suitable hardware, non-transitory machine-readable instructions, or a combination thereof. The hyperbaric chamber may correspond to the hyperbaric chamber 100, the hyperbaric chamber 200, and the hyperbaric chamber 300.

At block 2102, a first opening of a first union enclosure section may be connected to a first door section using disengagble connectors. The first union section may include a first top wall, a first bottom wall, a first sidewall having the first opening, a second sidewall having a second opening, a third sidewall having a third opening, and a fourth sidewall having a fourth opening. The first sidewall, the second sidewall, the third sidewall, and the fourth sidewall may be connected to the first top wall and the first bottom wall to form an open enclosure. The first union enclosure section may correspond to the first union section 104. The first door section may correspond to the first door section 102. The disengagable connectors may be, for example, bolts and nuts.

At block 2104, a plurality of end enclosure sections may be connected one of directly or indirectly to each of the second opening, the third opening and the fourth opening of the first union section enclosure. In an example, the plurality of end enclosure sections may include a first end enclosure section, a second end enclosure section, and a third end enclosure section. The first end enclosure section may correspond to the first end section 108, the second end enclosure section may correspond to the second end section 110, and the third end enclosure section may correspond to the third end section 118. The first door section, the first union enclosure section, and the plurality of end enclosure sections may be a part of plurality of enclosure sections of the hyperbaric chamber.

In an example, the method 2100 may include connecting, using disengagable connectors, the third opening to a first seat section and the first seat section to the first end enclosure section. A first seat for a patient may be provided, which may be accommodated by the first seat section and the first end enclosure section. The fourth opening of the first union enclosure section may be connected to the second end enclosure section. The second end enclosure section is to accommodate an attender for a patient. The second opening of the first union enclosure section may be connected to the second seat section. The second seat section may be connected to the first spacer section, the first spacer section may be connected to the third seat section, and the third seat section may be connected to the first end enclosure section. The sections may be connected using disengagble connectors, such as bolts and nuts. A stretcher may be provided for a patient. The stretcher may be accommodated by the second seat section, the first spacer section, the third seat section, and the third end section. The first seat section, the second seat section, the third seat section, the first spacer section, the first seat, the first end enclosure section, the second end enclosure section, the third end enclosure section, and the stretcher may be part of the plurality of enclosure sections of the hyperbaric chamber. The first seat section, the second seat section, and the third seat section. The first seat section may correspond to the first seat section 106, the second seat section may correspond to the second seat section 112, and the third seat section may correspond to the third seat section 116. The first spacer section may correspond to the first spacer section 114.

Although the present subject matter has been described with reference to specific embodiments, this description is not meant to be construed in a limiting sense. Various modifications of the disclosed embodiments, as well as alternate embodiments of the subject matter, will become apparent to persons skilled in the art upon reference to the description of the subject matter.

I/We claim:

1. A hyperbaric chamber for hyperbaric oxygen therapy, the hyperbaric chamber comprising:
a plurality of enclosure sections comprising:
a first union enclosure section having a first top wall, a first bottom wall, a first sidewall having a first opening, a second sidewall having a second opening, a third sidewall having a third opening, and a fourth sidewall having a fourth opening, the first sidewall, the second sidewall, the third sidewall, and the fourth sidewall connected to the first top wall and the first bottom wall to form an open enclosure,
a first door section comprising a first door frame and a first door, the first door section connectable to the first opening of the first union enclosure section, and
a plurality of end enclosure sections connectable one of directly or indirectly to each of the second opening, the third opening, and the fourth opening of the union enclosure section,
wherein each of the plurality of sections is connectable to each other by disengagable connectors.

2. The hyperbaric chamber as claimed in claim 1, wherein the plurality of enclosure sections comprises a first end enclosure section, a second end enclosure section, a third end enclosure section, a first seat section, a second seat section, a third seat section, and a first spacer section, wherein:
the third opening of the first union enclosure section is connectable to the first seat section and the first seat section is connectable to the first end enclosure section, the first seat section and the first end enclosure section to accommodate a first seat for a patient,
the fourth opening of the first union enclosure section is connectable to the second end enclosure section, the second end enclosure section to accommodate an attender for a patient, and
the second opening of the first union enclosure section is connectable to the second seat section, the second seat section is connectable to the first spacer section, the first spacer section is connectable to the third seat section, and the third seat section is connectable to the third end enclosure section, the second seat section, the first spacer section, the third seat section, and the third end enclosure section to accommodate a stretcher for a patient.

3. The hyperbaric chamber as claimed in claim 2, wherein the plurality of enclosure sections comprises
a second union enclosure section comprising:
a second top wall, a second bottom wall, a fifth sidewall having a fifth opening, a sixth sidewall having a sixth opening, a seventh sidewall having a seventh opening, an eighth sidewall having an eighth opening, the fifth sidewall, the sixth sidewall, the seventh sidewall, and the eighth sidewall connected to the second top wall and the second bottom wall to form an open enclosure,
a second door section comprising a second door frame and a second door,
a fourth end enclosure section,
a fifth end enclosure section,
a fourth seat section, and
a second spacer section,
wherein:
the fifth opening of the second union enclosure section is connectable to the second door section,
the sixth opening of the second union enclosure section is connectable to the second spacer section and the second spacer section is connectable to the first door section,
the seventh opening of the second union enclosure section is connectable to the fourth seat section and the fourth seat section is connectable to the fourth end enclosure section, the fourth seat section and the fourth end enclosure section to accommodate a second seat for a patient; and
the eighth opening of the second union enclosure section is connectable to the fifth end enclosure section, the fifth end enclosure section to accommodate an attender for a patient.

4. The hyperbaric chamber as claimed in claim 3, wherein the plurality of enclosure sections comprises:
a third union enclosure section comprising:
a third top wall, a third bottom wall, a ninth sidewall having a ninth opening, a tenth sidewall having a tenth opening, an eleventh sidewall having an eleventh opening, a twelfth sidewall having a twelfth opening, the ninth sidewall, the tenth sidewall, the eleventh sidewall, and the twelfth sidewall connected to the third top wall and the third bottom wall to form an open enclosure, a third door section comprising a third door frame and a third door,
a sixth end enclosure section,
a third spacer section;
an end plate, and
wherein:
the ninth opening of the third union enclosure section is connectable to the third door section,
the tenth opening of the third union enclosure section is connectable to the third spacer section, the third spacer section is connectable to the second door section,
the eleventh opening of the third union enclosure section is connectable to the end plate, and
the twelfth opening of the third union enclosure section is connectable to the sixth end enclosure section, the sixth end enclosure section to accommodate an attender for a patient.

5. The hyperbaric chamber as claimed in claim 2, wherein the plurality of enclosure section comprises a fourth spacer section, wherein:
the first seat section is connectable to the fourth spacer section, the fourth spacer section is connectable to the first end enclosure section, and wherein the hyperbaric chamber comprises:
a seat accommodated by the first seat section, the first end enclosure section, and the fourth spacer section, wherein the seat is reclinable.

6. The hyperbaric chamber as claimed in claim 2, wherein the first seat section comprises:
a first frame;
a second frame displaced at a distance from the first frame, wherein the first frame and the second frame are hollow and are rectangular in shape; and
a seat section shell coupled between the first frame and the second frame, wherein the seat section shell is hollow and is cuboid-shaped.

7. The hyperbaric chamber as claimed in claim 6, wherein the first seat section comprises:
a plurality of door ribs displaced at a distance from each other and extending from the first frame to the second frame on the seat section shell;
a first seal disposed on the first frame to provide a sealing enclosure between the coupling of the at least one seat section with another section; and
a second seal disposed on the second frame to provide sealing enclosure between the coupling of the at least one seat section with another section.

8. The hyperbaric chamber as claimed in claim 6, wherein the first seat section comprises a first viewport and a second view port on lateral faces of the seat section shell to enable viewing outside the hyperbaric chamber.

9. The hyperbaric chamber as claimed in claim 2, wherein each of the first end enclosure section, the second end enclosure section, and the third end enclosure comprises:
an end section shell, wherein the end section shell is hollow and is cuboid-shaped;
an end section front frame attached to the end section shell, wherein the end section front frame is hollow and is rectangular-shaped;
an end plate disposed at a distance from the end section front frame and being attached to the end section shell, wherein the end plate is solid and is rectangular shaped; and
a plurality of end section ribs spaced at a distance from each other and extending from the end plate to the end section front frame on the end section shell to enhance the strength of the end section.

10. The hyperbaric chamber as claimed in claim 2, comprising:
a first lighting assembly coupled to the first union enclosure section to provide lighting; and
a second light assembly coupled to the first seat section to provide lighting.

11. The hyperbaric chamber as claimed in claim 2, comprising a drain hole coupled to the first seat section for draining out liquids out of the hyperbaric chamber.

12. The hyperbaric chamber as claimed in claim 2, wherein the first union enclosure section, the first seat section, the second seat section, the third seat section, the first spacer section, the first end enclosure section, the second end enclosure section, the third end enclosure section, and the first door section are of rectangular cross-section.

13. The hyperbaric chamber as claimed in claim 1, wherein:
the first door frame is to enclose and to support the first door, the first door frame comprises a first end, a second end, a third end, and a fourth end, the first end is opposite the second end, and the third end is opposite the fourth end,
the first door is slideable from the first end to the second end to allow or prevent entry and exit of patients into and outside the hyperbaric chamber, wherein the first door section comprises:
a door shell assembly coupled to the first door frame to provide structural support to the first door section; and
a skirt seal disposed between the first door frame and the first door shell assembly to provide a sealing enclosure to the coupling between the first door frame and the door shell assembly.

14. The hyperbaric chamber as claimed in claim 13, wherein the first door frame comprises:
a door flange;
a first door support flange coupled to the door flange;
a second door support flange coupled to the first door flange;
a first guideway block provided at the third end between the first door support flange and the second door support flange; and
a second guideway block provided at the fourth end between the first door support flange and the second door support flange, wherein the first guideway block and the second guideway block are to support the sliding of the door.

15. The hyperbaric chamber as claimed in claim 13, wherein the door shell assembly comprises:
a door shell, wherein the door shell is hollow and is cuboid-shaped;
a head flange and a tail flange coupled to ends of the door shell, wherein the head flange and the tail flange are hollow and are rectangular shaped; and
a plurality of door ribs to enhance the strength of the door shell assembly, wherein the plurality of door ribs are spaced at a distance from each other and extending from the head flange to the tail flange on the door shell.

16. The hyperbaric chamber as claimed in claim 13, wherein the first door section comprises:
a first safety light curtain coupled to the first door frame; and
a second safety light curtain coupled to first the door frame and displaced at a distance from the first safety light curtain, the first safety light curtain and the second safety light curtain to prevent the first door from sliding towards the second end if a person is in a path of the first door.

17. The hyperbaric chamber as claimed in claim 1, wherein the first door frame is to enclose and is to support the first door, the first door being slideable in the first door frame, wherein the first door section comprises:
a door shell assembly coupled to the first door frame to provide structural support to the first door section; and
an actuator coupled to the first door frame and to the first door to cause sliding of the first door in the first door frame.

18. The hyperbaric chamber as claimed in claim 17, wherein the actuator is one of: an electrical actuator or a pneumatic actuator.

19. The hyperbaric chamber as claimed in claim 17, wherein the first door section comprises a door switch coupled to the first door frame to actuate the actuator.

20. The hyperbaric chamber as claimed in claim 1, wherein the first union enclosure section comprises:
a first bracket disposed between and coupled to the first top wall, to the first bottom wall, to the first sidewall, and to the second sidewall;
a second bracket disposed between and coupled to the first top wall, to the first bottom wall, to the second sidewall and to the third sidewall;
a third bracket disposed between and coupled to the first top wall, to the first bottom wall, to the third sidewall, and the fourth sidewall; and
a fourth bracket disposed between and coupled to the first top wall, to the first bottom wall, to the fourth sidewall, and to the first sidewall, wherein the first bracket, the second bracket, the third bracket, and the fourth bracket are L-shaped.

21. The hyperbaric chamber as claimed in claim 20, wherein the first top wall comprises:
a top sheet, wherein the top sheet is of rectangular shape with square cut corners, wherein the top sheet comprises:
a first joint disposed at a corner and coupled to the first bracket;
a second joint disposed at a corner and coupled to the second bracket;
a third joint disposed at a corner and coupled to the third bracket; and
a fourth joint disposed at a corner and coupled to the fourth bracket.

22. The hyperbaric chamber as claimed in claim 21, wherein the first joint, the second joint, the third joint, and the fourth joint are hyperbolic-paraboloid shaped.

23. The hyperbaric chamber as claimed in claim 1, wherein the first top wall comprises:
a top sheet;
a first plurality of ribs disposed on the top sheet to enhance the strength of the first top wall; and
a second plurality of ribs disposed on the top sheet perpendicular to the first plurality of ribs to enhance strength of the first top wall, wherein a rib of the first plurality of ribs is attached to at least a rib of the second plurality of ribs.

24. The hyperbaric chamber as claimed in claim 1, wherein the first bottom wall comprises:
a bottom sheet;
a third plurality of ribs disposed on the bottom sheet to enhance the strength of the first bottom wall; and
a fourth plurality of ribs disposed on the bottom sheet perpendicular to the third plurality of ribs to enhance strength of the first bottom wall, wherein a rib of the third plurality of ribs is attached to at least a rib of the fourth plurality of ribs.

25. A method of assembling a hyperbaric chamber, comprising:
connecting, using disengagable connectors, a first opening of the first union enclosure section to a first door section, wherein the first union enclosure section comprises a first top wall, a first bottom wall, a first sidewall having the first opening, a second sidewall having a second opening, a third sidewall having a third opening, a fourth sidewall having a fourth opening, wherein the first sidewall, the second sidewall, the third sidewall, and the fourth sidewall are connected to the first top wall and the first bottom wall to form an open enclosure, wherein the first door section comprises a first door frame and a first door;
connecting, using disengagable connectors, a plurality of end enclosure sections one of directly or indirectly to each of the second opening, the third opening and the fourth opening of the first union enclosure section, wherein the first union enclosure section, the plurality of end enclosure sections, and the first door section are part of a plurality of enclosure sections of the hyperbaric chamber.

26. The method as claimed in claim 25, comprising:
connecting, using disengagable connectors, the third opening of the first union enclosure section to the first seat section and the first seat section to the first end enclosure section;
providing a first seat for a patient, the first seat section and the first end enclosure section to accommodate the first seat;
connecting, using disengagable connectors, the fourth opening of the first union enclosure section to the second end enclosure section, the second end enclosure section to accommodate an attender for a patient;
connecting, using disengagable connectors, the second opening of the first union enclosure section to a second seat section, the second seat section to the first spacer section, the first spacer section to a third seat section, and the third seat section to the first end enclosure section; and
providing a stretcher for a patient, the second seat section, the first spacer section, the third seat section, and the third end enclosure section to accommodate the stretcher, wherein the first seat section, the second seat section, the third seat section, the first spacer section, the first end enclosure section, the second end enclosure section, the third end enclosure section, the first seat, and the stretcher are part of the plurality of enclosure sections.
